(19) United States
(12) Patent Application Publication
(10) Pub. No.: US 2023/0111589 A1
(43) Pub. Date: Apr. 13, 2023

(54) Expandable Joint Compound Composition and Method of Making Same

(71) Applicant: Panel Rey, S.A., Monterrey (MX)

(72) Inventors: Amba Ayambem, Garcia (MX); Arturo Palacios Parga, San Nicolas de los Garza (MX); Julian Elizondo Urbina, Escobedo (MX); Eder Tega Sagaon, General Escobedo (MX)

(21) Appl. No.: 17/957,763

(22) Filed: Sep. 30, 2022

Related U.S. Application Data
(60) Provisional application No. 63/254,220, filed on Oct. 11, 2021.

(51) Int. Cl. C04B 24/42; C04B 14/18; C04B 40/00; C04B 7/34; C04B 14/10; C04B 24/20

(52) U.S. Cl. CPC C04B 24/42; C04B 14/185; C04B 40/0039; C04B 7/34; C04B 14/10; C04B 24/20; C04B 2111/00681

(57) ABSTRACT

A joint compound formulation is a mixture of a clay, cellulose ethers, expanded perlite, an adhesive, limestone, water, and a surfactant. The surfactant includes an alkyl trisiloxane. In addition a foam stabilizer, sodium dodecyl diphenyl ether disulfonate, may be added to the formulation.

### CROSS REFERENCE TO RELATED PATENT APPLICATIONS

This invention claims priority from U.S. Provisional Patent Application No. 63/254,220, filed Oct. 11, 2021, which is hereby incorporated by reference.

### FIELD OF THE INVENTION

This invention relates to a joint compound formulation that expands (achieves lower density) when mixed with water.

### BACKGROUND OF THE INVENTION

Over the years, lightweight ready-mix joint compound has continued to gain wide usage because the typical 5-gallon pail of the material is lighter to haul around and the finishers, who spend the working day carrying pans filled with joint compound appreciate that their arms are less tired at the end of the day. The lightweight is traditionally achieved by incorporating expanded perlite as a filler in the joint compound. There is, however, an upper limit to the amount of perlite that can be added to the joint compound. To add perlite beyond a certain amount may invite a deterioration in the working properties of the joint compound.

There are two types of joint compound, the setting type and the drying type.

Components of a joint compound include attapulgite clay which helps to thicken and provide dimensional stability to the compound. An example is Min-U Gel FG, supplied by Active Minerals International LLC of Sparks, Md.

Cellulose ethers are the principal thickeners used in joint compounds especially because they play dual roles of thickening and water holding to extend working time. An example is MHS 200000, manufactured by SE Tylose GmbH & Co, KG, Wiesbaden, Germany. In lieu of cellulose there or in combination with it, starch could also be used. An example is RD 940 or Papigel Plus 515, both supplied by Ingredion Incorporated of Westchester, Ill.,

Expanded perlite is used to create a lighter weight joint compound. There are two general types of expanded perlite, the uncoated and the coated types. Either is used in joint compounds, depending on the specific characteristic and working property one wishes to accomplish. Examples of expanded perlite include SPH3RA STR, manufactured by SPH3RA, Microsil S200, manufactured by Omnya AG, Oftringen, Switzerland, and Sil-Cell 43-34 manufactured by the Silbrico Corporation, Illinois, USA.

Mica and talc are often part of joint compound formulations, acting as both rheology modifiers as well as offering crack resistance. One grade of mica that is commonly used is SG-70, supplied by Southeastern Performance Minerals LLC, Sandersville, Ga.

Vinyl acetate (VAc) and ethylene vinyl acetate (EVA) in latex form serve as the primary binders in the joint compound formulation. An example is Adhesin EP-1634, supplied by Henkel AG & Co. KGaA, Dusseldorf, Germany

Limestone makes up the largest composition by weight and is the primary filler. Depending on the particle size distribution, it also contributes to the rheology of the joint compound. An example is Molienda Interna Regio Marmol, supplied by Regio Marmol, S.A. de C.V., Durango, Mexico.

Before using a joint compound, it is first thoroughly mixed using an electric drill, a potato masher, or a spatula. This mixing step promotes greater wetting between the components of the joint compound formulation which invariably results in a higher density of the mixed material compared to the original unmixed material. For example, a carton of USG Plus 3 Lightweight joint compound purchased in Houston, Tex. had an unmixed density of 10.01 lb./gal. When mixed however, the same joint compound increased in density to 11.27 lb./gal. Considering a net product weight of 33.11 lb. therefore, this densification resulted in a product volume reduction from 3.31 gallons to 2.94 gallons.

### SUMMARY OF THE INVENTION

The drying-type joint compound formulation of the present invention undergoes expansion, rather than densifying. The volumetric expansion is achieved by introducing a small quantity of an alkyl trisiloxane, specifically 3-(Polyoxyethylene)propylheptamethyltrisiloxane. Specific examples of alkyl trisiloxanes that have been found to work well are Silsurf A008 and Silsurf A008-UP (both of which are manufactured by the SilTech Corporation, East York, ON M4H 1G5, Canada). These compounds impart very low surface tension along with ample and stable foam generation. For example, at 0.1% dosage, Silsurf A008-UP imparts a surface tension of 21.5 mN/m and a stable foam height well in excess of 300 ml (1% solution, 5 minutes) as measured by the Ross-Miles method.

Optionally, a co-surfactant such as sodium dodecyl diphenyl ether disulfonate could be included in the formulation. An example of the disulfonate is Dowfax 2A1, manufactured by the Dow Chemical Company, Midland, Mich. Sodium dodecyl diphenyl ether disulfonate belongs to a unique class of surfactants called gemini surfactants because it is a single molecule with two hydrophilic head groups and two hydrophobic tails. When the two surfactants were used in combination, the dosage level (weight percent) of the respective surfactants were 0.03% for Silsurf A008-UP and 0.0225% for Dowfax 2A1 (actives). Without seeking to be bound by theory, we surmise that it is likely that the sodium dodecyl diphenyl ether disulfonate acts as a stabilizer to the microfoams generated by alkyl trisiloxane.

In the inventive system, the ready-mix joint compound is manufactured in the traditional manner and the surfactant(s) is introduced either along with the other formulation components, or after the finished joint compound mixture exits the mixer. For example, during packaging, the aforementioned surfactant system could be sprayed (or introduced in some manner) into an empty container just before the container is filled with joint compound. The surfactant system could also be introduced into the container immediately after the container has been filled with the desired weight/volume of joint compound (in which case the surfactant system would sit on top of the joint compound). A third option could be for the surfactant system to be introduced at some point while the container is being filled with joint compound (meaning that it is embedded/buried within the joint compound). Whichever dosage or feed option is selected, the surfactant system would remain dormant in the container until the joint compound is mixed, at which point it would initiate the generation of stable microbubbles, resulting in a volumetric expansion (and lower density) of the joint compound.

### DETAILED DESCRIPTION OF THE PREFERRED EMBODIMENTS

For example, Table 1 below shows a representative conventional joint compound formula, PR-1.

TABLE 1

| | Quantity |
|---|---|
| Ingredient | (kilograms) |
| Starch | 0.4 |
| Clay | 3 |
| Thickener | 0.35 |
| Expanded | 6.2 |
| perlite | |
| Limestone | 47.8 |
| Biocide | 0.19 |
| Latex | 2.5 |
| Water | 39.56 |
| Total Weight | 100 |

Characteristics

| | |
|---|---|
| Viscosity, BU | 360 |
| Density, g/ml | 1.16 |

As shown in Table 2 below, the addition of the surfactant system to PR-1 (with mixing) to create PR-1-EXP results in a reduction in density from 1.16 g/ml to 0.98 g/ml as well as a reduction in viscosity from 360 BU to 302 BU. The reduction in density translates to an 18.40% increase in volume for the same weight of product.

TABLE 2

| | | Dosage (actives) | Range |
|---|---|---|---|
| Product - | Quantity | (% by weight of | (% by weight |
| PR-1-EXP | (grams) | PR-1) | of PR-1) |
| PR-1 | 322.43 | | |
| Silsurf A008-UP | 0.097 | 0.03 | 0.005-0.40 |
| Dowfax 2A1 | 0.161 | 0.02 | 0.005-0.50 |
| Total Weight | 322.688 | | |

Characteristics

| | |
|---|---|
| Viscosity, BU | 302 |
| Density, g/ml | 0.98 |

An important performance characteristic of joint compounds is drying shrinkage. Lower shrinkage is generally desirable because it translates to greater coverage for a given volume of joint compound. Conversely, it means that fewer coats of the joint compound would be required to achieve the desired surface smoothness. With the inventive surfactant system, an unexpected reduction in shrinkage results.

Shrinkage testing was carried out in duplicates, and the results are shown in Table 3. Between PR-1 and PR-1-EXP, the average shrinkage value fell from 21.80% to 17.80%. Water was added to PR-1 in order to bring its viscosity down to that of PR-1-EXP (302 BU). The average value of the new watered-down PR-1 displayed an even higher average shrinkage value of 23.7%. Therefore, at equivalent viscosity, there was a roughly 25% reduction in shrinkage between watered down PR-1 and PR-1-EXP which contained the inventive surfactant system.

TABLE 3
Shrinkage results for PR-1 samples

| | Viscosity | | | |
|---|---|---|---|---|
| Product | (BU) | Shrinkage-1 | Shrinkage-2 | Average |
| PR-1 | 360 | 21.7% | 21.8% | 21.8% |
| PR-1-EXP | 302 | 18.6% | 16.9% | 17.8% |
| PR-1 (watered down) | 302 | 23.5% | 23.9% | 23.7% |

Shrinkage data for the joint compound after volumetric expansion was essentially unchanged compared to the original unexpanded joint compound which suggests that the microbubbles within the inventive expanded joint compound were of relatively sound structural integrity. A volumetric expansion of the inventive joint compound coupled with lower shrinkage translates into greater coverage for an initial volume of the corresponding unmixed, unexpanded inventive joint compound versus conventional joint compounds.

The surfactant can be dry mixed with the ingredients before the addition of water in a mixer. The surfactant can be dosed into the joint compound inside the mixer along with other ingredients. The surfactant can be added to the mixed ingredients upon exiting the mixer without additional mixing. Particularly, when packaging the joint compound in each individual container the surfactant can be added to the container while the container is being filled with joint compound. For example, one could situate a precision fluid dispenser in close proximity to a spout where the joint compound emerges to fill the container. The precision fluid dispenser would spray measured quantities of each surfactant into the container. An example of a precision fluid dispenser that could be employed for this is ECO-DUO which is manufactured by ViscoTec Pumpen-u. Dosiertechnik GmbH, 84513 Töging a. Inn, Germany. Another example is the Valvemate 8000 dispensing system by Nordson EFD LLC, USA.

Using the precision fluid dispenser, the surfactant could be added to an empty container prior to being filled with the joint compound comprising the mixed ingredients. The surfactant could be added to the container when the container is partially filled with the joint compound comprising the mixed ingredients to a predetermined level (for example, 50% of the final container volume). The surfactant could be added to the container when the container is essentially full of the joint compound comprising the mixed ingredients. The surfactant could also be added to the container at multiple fill levels.

1. In a joint compound formulation having at least:
a. a clay;
b. a thickener;
c. expanded perlite;
d. an adhesive;
e. limestone; and
f. water;
an improvement comprising the addition of a surfactant.

2. The joint compound formulation of claim 1, wherein the surfactant is an alkyl trisiloxane.

3. The joint compound formulation of claim 2, wherein the alkyl trisiloxane makes up between 0.005% and 0.2% by weight of the formulation.

4. The joint compound formulation of claim 2, wherein the formulation further includes a gemini surfactant.

5. The joint compound formulation of claim 4, wherein the gemini surfactant is sodium dodecyl diphenyl ether disulfonate.

6. The joint compound formulation of claim 2, wherein the formulation further includes a foam stabilizer surfactant.

7. The joint compound formulation of claim 6, wherein the foam stabilizer surfactant is sodium dodecyl diphenyl ether disulfonate.

8. The joint compound formulation of claim 7, wherein sodium dodecyl diphenyl ether disulfonate makes up between 0.01% and 0.3% by weight of the formulation.

9. A method for formulating a joint compound formulation having at least the following ingredients:
a. a clay;
b. a thickener;
c. expanded perlite;
d. an adhesive;
e. limestone; and
f. water;
comprising the steps of:
i. mixing the ingredients to create mixed ingredients; and
ii. adding a surfactant to the formulation.

10. The method for formulating a joint compound formulation of claim 9, wherein the surfactant is an alkyl trisiloxane.

11. The method for formulating a joint compound formulation of claim 10, wherein the alkyl trisiloxane makes up between 0.005% and 0.2% by weight of the formulation.

12. The method for formulating a joint compound formulation of claim 10, wherein the formulation further includes a gemini surfactant.

13. The joint compound formulation of claim 12, wherein the gemini surfactant is sodium dodecyl diphenyl ether disulfonate.

14. The method for formulating a joint compound formulation of claim 10, wherein the formulation further includes a foam stabilizer surfactant.

15. The method for formulating a joint compound formulation of claim 14, wherein the foam stabilizer surfactant is sodium dodecyl diphenyl ether disulfonate.

16. The method for formulating a joint compound formulation of claim 15, wherein sodium dodecyl diphenyl ether disulfonate makes up between 0.01% and 0.3% by weight of the formulation.
